(19) United States
(12) Patent Application Publication
(10) Pub. No.: US 2009/0234839 A1
(43) Pub. Date: Sep. 17, 2009

(54) SMART SENSOR BASED ENVIRONMENT FOR OPTIMIZING A SELECTION OF MEAL PLANS

(75) Inventors: Robert Lee Angell, Salt Lake City, UT (US); Robert R. Friedlander, Southbury, CT (US); James R. Kraemer, Santa Fe, NM (US)

Correspondence Address: DUKE W. YEE, YEE AND ASSOCIATES, P.C., P.O. BOX 802333, DALLAS, TX, 75380, US

(73) Assignee: International Business Machines Corporation, Armonk (US)

(21) Appl. No.: 12/049,580

(22) Filed: Mar. 17, 2008

(51) Int. Cl. G06F 7/06; G06F 17/30

(52) U.S. Cl. 707/5; 707/E17.017

(57) ABSTRACT

A computer implemented method, apparatus, and computer program product for selection of meal plans. In one embodiment, a set of prospective guests are identified from at least one of a set of sensors collecting historical attendance data and a calendaring application. A set of nutritional requirements is then identified for the set of prospective guests. Thereafter, a set of meal plans is selected on an availability of ingredients and the nutritional requirements of the set of prospective guests, wherein the availability of ingredients is determined by sensors from the set of sensors monitoring the ingredients.

### BACKGROUND OF THE INVENTION

1. Field of the Invention

The present invention is related generally to a data processing system and in particular to a method and apparatus for planning meals. More particularly, the present invention is directed to a computer implemented method, apparatus, and computer-usable program code for planning meals using smart sensors for optimizing a selection of meal plans based, in part, upon a presence of a set of prospective guests.

2. Description of the Related Art

A kitchen is a location in which meals are prepared. A kitchen may be located in a residential building, such as a house or apartment. In addition, kitchens may be located in places of business, such as restaurants, hospitals, long-term care facilities, cruise ships, or other similar locations.

Kitchens may include storage units for storing ingredients used for preparing meals. The ingredients may include meats, fruits, vegetables, starch-based ingredients, condiments, seasonings, or other edible substances commonly incorporated into meals.

The successful planning and preparation of meals may require advance planning. For example, a collection of recipes may be required to identify necessary ingredients. Similarly, an availability of ingredients may be determined before meal preparation begins. Other relevant information may be useful, such as knowing how many guests will be present for a given meal, and whether or not the guests have particular nutritional requirements that should or must be satisfied.

### SUMMARY OF THE INVENTION

The illustrative embodiments provide a computer implemented method, apparatus, and computer-usable program code for optimizing a selection of meal plans. In one embodiment, a set of prospective guests are identified from at least one of a set of sensors collecting historical attendance data and a calendaring application. A set of nutritional requirements is then identified for the set of prospective guests. Thereafter, a set of meal plans is selected on an availability of ingredients and the nutritional requirements of the set of prospective guests, wherein the availability of ingredients is determined by sensors from the set of sensors monitoring the ingredients.

### BRIEF DESCRIPTION OF THE DRAWINGS

FIG. 1 is a pictorial representation of a network of data processing systems in which illustrative embodiments may be implemented;

FIG. 2 is a block diagram of a data processing system in accordance with an illustrative embodiment of the present invention;

FIG. 3 is a block diagram illustrating a system for use in optimizing the generation of meal plans in accordance with an illustrative embodiment;

FIG. 4 is a block diagram of a storage unit including a set of mass sensor shelves in accordance with an illustrative embodiment;

FIG. 5 is a block diagram of a mass sensor shelf having a mass sensor grid and consumable items on the shelf in accordance with an illustrative embodiment;

FIG. 6 is a diagram illustrating a meal plan stored in a meal plan database in accordance with an illustrative embodiment;

FIG. 7 is a diagram of a record stored in a guest profile database in accordance with an illustrative embodiment;

FIG. 8 is a diagram depicting sample fields of a record stored in a historical attendance database in accordance with an illustrative embodiment;

FIG. 9 is a flowchart of a process for optimizing a selection of meal plans in accordance with an illustrative embodiment;

FIG. 10 is a flowchart of a process for identifying a set of prospective guests in accordance with an illustrative embodiment; and

FIG. 11 is a flowchart of a process for identifying nutritional requirements of a set of prospective guests in accordance with an illustrative embodiment.

### DETAILED DESCRIPTION OF THE PREFERRED EMBODIMENT

As will be appreciated by one skilled in the art, the present invention may be embodied as a system, method, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer-usable or computer-readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer-usable program code may be transmitted using any appropriate medium, including, but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

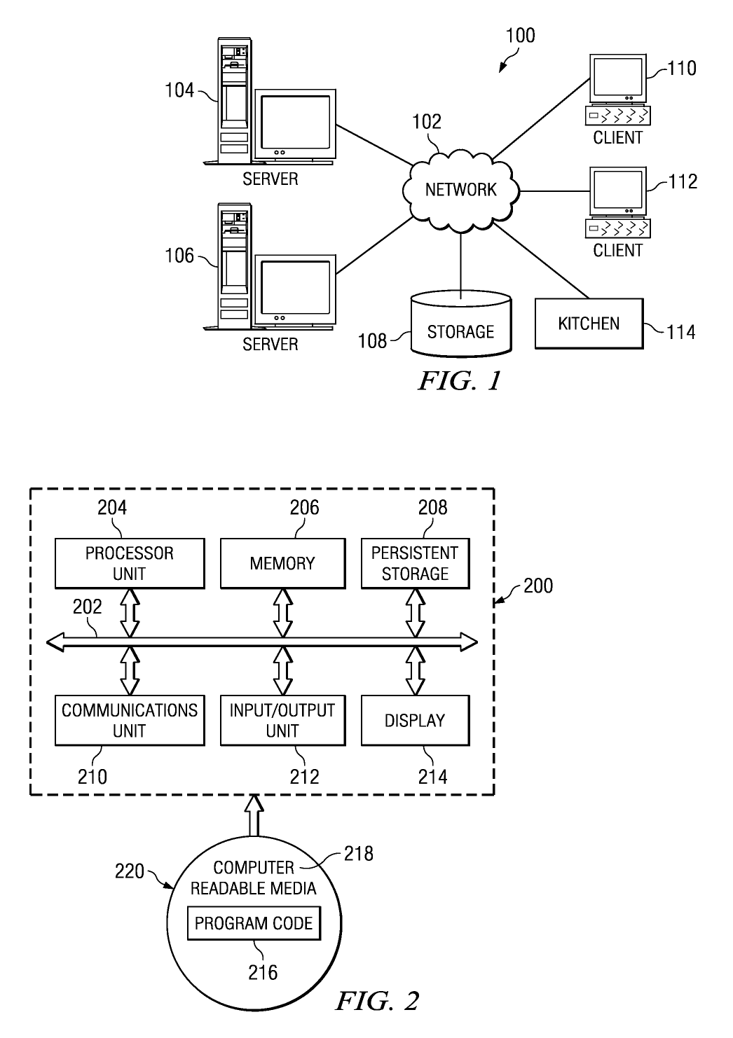

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers that includes network 102. Network 102 is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. Servers 104 and 106 are servers that may store nutritional requirements data or other information for use in planning meals. For example, servers 104 and 106 may store results of the latest medical studies indicating which foods are known to lower cholesterol, counteract the effects of high blood pressure, or provide an adequate amount of calories for an endurance athlete.

Clients 110 and 112 connect to network 102. Clients 110 and 112 may be, for example, personal computers or network computers. In the depicted example, server 104 provides data, such as boot files, operating system images, and applications to clients 110 and 112. Clients 110 and 112 are clients to server 104 in this example. Clients 110 and 112 may be used to host software applications and interface with hardware components for use in the generation of meal plans. A meal plan is a guide that provides information about how much and what kinds of food should be eaten and when.

In this illustrative example in FIG. 1, network data processing system 100 includes kitchen 114. Kitchen 114 is one or more locations in which all or part of meal planning and/or preparation occurs. Kitchen 114 may include storage units, ingredients used in the preparation of meals, appliances, or any other equipment that may be used for facilitating the planning or preparation of meals. Kitchen 114 may include one or more clients linked to the various components found within kitchen 114. In addition, the one or more components of kitchen 114 may be networked with other clients and servers of network data processing system 100.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments. Network data processing system 100 may include additional servers, clients, and other devices not shown.

Turning now to FIG. 2, a block diagram of a data processing system is depicted in accordance with an illustrative embodiment of the present invention. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer-usable program code, or computer-readable program code that may be read and executed by a processor in processor unit 204. The program code in the different embodiments may be embodied on different physical or tangible computer-readable media, such as memory 206 or persistent storage 208.

Program code 216 is located in a functional form on computer-readable media 218 that is selectively removable and may be loaded onto or transferred to data processing system 200 for execution by processor unit 204. Program code 216 and computer-readable media 218 form computer program product 220 in these examples. In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive, a thumb drive, or a flash memory that is connected to data processing system 200. The tangible form of computer-readable media 218 is also referred to as computer recordable storage media. In some instances, computer-readable media 218 may not be removable.

Alternatively, program code 216 may be transferred to data processing system 200 from computer-readable media 218 through a communications link to communications unit 210 and/or through a connection to input/output unit 212. The communications link and/or the connection may be physical or wireless in the illustrative examples. The computer-readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer-readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Meal plans may be selected according to any number of relevant criteria. A meal plan is a guide that provides information about how much and what kinds of food should be eaten and when. The criteria for selecting meal plans may include, for example, nutritional requirements of a set of prospective guests. Nutritional requirements are guidelines governing the intake of food by a particular user. For example, nutritional requirements may state that body builders require a certain level of protein each day or that endurance athletes consume a sufficient amount of carbohydrates. Nutritional requirements may also specify an amount of sugar that may be consumed by a diabetic on a daily basis. The nutritional requirements may be determined based upon a set of nutritional profiles for each guest of the set of prospective guests. In addition, the nutritional requirements may be determined according to a medical profile of each guest of the set of prospective guests.

Meal plans may also be selected based upon the availability of ingredients. Availability of ingredients not only includes the existence of a particular ingredient, but the existence of a sufficient amount of the ingredient to make enough food for a set of prospective guests. In addition, the availability of ingredients may be determined based upon a user's willingness purchase ingredients or other food items from a store.

Today, each member of a family or guests at an event frequently have their own unique diet policy. A diet policy is a set of dietary requirements/restrictions that make up a given diet. For example, the husband is an athlete trying to build muscle. Therefore, the husband will be on a high protein diet policy. The wife is on a doctor recommended low cholesterol and/or low sodium diet. The child is a diabetic and must adhere to a low sugar diet policy. In a family with multiple diverse diet policies such as this, meal planning and preparation can become incredibly complex. A user must determine one or more meals that will satisfy the combined diet policies' nutritional requirements and food restrictions for each family member. Frequently, a user will be forced to prepare multiple separate meals to satisfy the multiple diet policies due to the difficulties of coming up with a single meal to satisfy multiple diet policies.

Although users can consult diet/recipe books to obtain recipes to meet the requirements of a particular diet, a diet/recipe book will generally only provide recipes for a single diet policy. Manually searching for recipes that satisfy multiple different diet policies can be time consuming and burdensome.

In addition, preparing the meal(s) that satisfy multiple diverse diet policies can be difficult where a user is uncertain as to which ingredients are available in inventory, what amounts of those ingredients are available in inventory, and which ingredients need to be purchased/replaced. For example, refrigerators and cabinets are frequently overfilled with too many items. In such a case, a user may be unable to determine what ingredients are in inventory due to obscuring of one or more items behind multiple other items. In addition, empty or almost empty containers left in a refrigerator or cabinet can lead a user to believe that an ingredient, such as milk, is available in stock when in fact, there is an insufficient amount of that ingredient remaining to satisfy the measure requirements of a recipe.

The illustrative embodiments presented herein recognize that current methods for optimizing a selection of meal plans involve determining a set of prospective guests that may be present for a meal. The set of prospective guests is one or more persons that may be present for a meal. In one illustrative embodiment, the set of prospective guests is determined from a calendaring application. In another illustrative embodiment, the set of prospective guests is determined by extracting a pattern of attendance from a historical attendance database.

It will be appreciated by one skilled in the art that the words “optimize,” “optimization,” and related terms are terms of art that refer to improvements in speed and/or efficiency and do not purport to indicate that a process or computer program has achieved, or is capable of achieving, an “optimal” or perfectly speedy/perfectly efficient state. Furthermore, as used herein, optimization may be determined with reference to the selection of a set of meal plans from a meal plan database in accordance with one or more meal plan policies.

Therefore, the illustrative embodiments provide a computer implemented method, apparatus, and computer program product for optimizing a selection of meal plans, based in part, upon a set of prospective guests. In one embodiment, a set of prospective guests are identified from at least one of a set of sensors collecting historical attendance data and a calendaring application. A set of nutritional requirements is then identified for the set of prospective guests. Thereafter, a set of meal plans is selected on an availability of ingredients and the nutritional requirements of the set of prospective guests, wherein the availability of ingredients is determined by sensors from the set of sensors monitoring the ingredients.

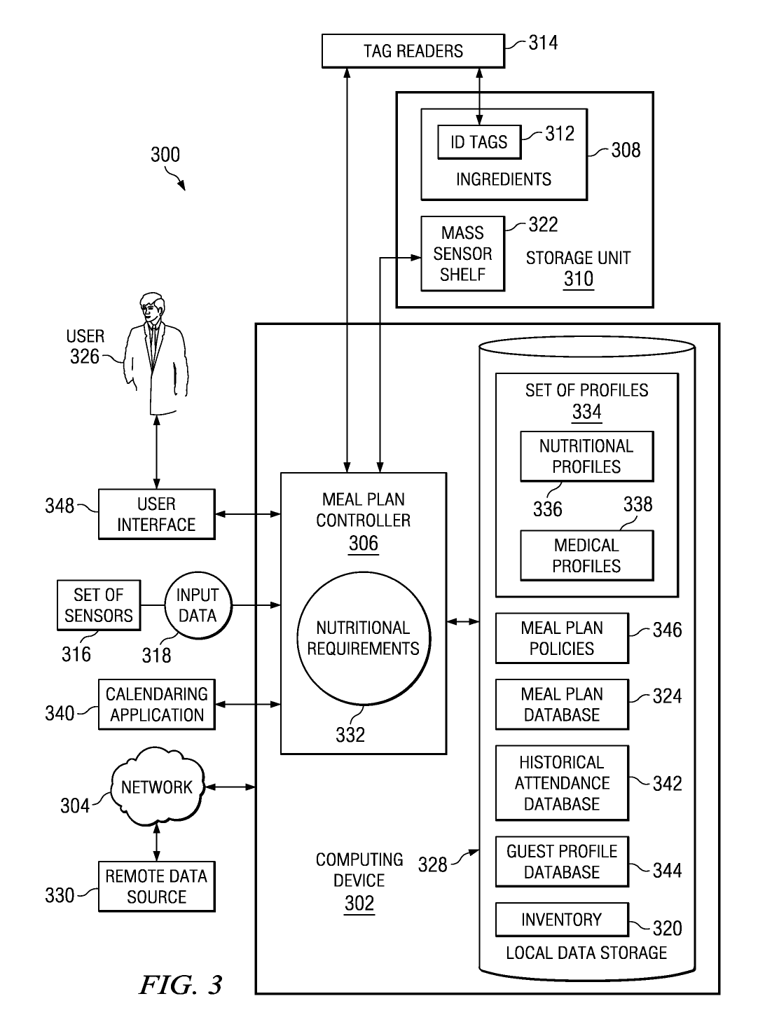

FIG. 3 is a block diagram illustrating a system for use in optimizing the generation of meal plans in accordance with an illustrative embodiment. System 300 is a system such as network data processing system 100 in FIG. 1. System 300 includes computing device 302. Computing device 302 is a computing device such as client 110 in FIG. 1. Computing device 302 is connected to network 304. Network 304 is a network such as network 102 in FIG. 1.

Computing device 302 includes meal plan controller 306 for optimizing a selection of meal plans. Meal plan controller 306 is a software program that selects meal plans based at least upon an availability of ingredients 308 and the attendance of prospective guests. In other embodiments, meal plans may be selected based upon other criteria, such as, for example, seasons, holidays, age, or ethnicity of guests.

Ingredients 308 are food-based items that may be incorporated into a meal. Ingredients 308 include, for example, fruits, vegetables, meats, condiments, sauces, garnishes, or any other edible items. Ingredients 308 are stored in storage unit 310.

Storage unit 310 is a repository for storing and/or displaying ingredients 308. A storage unit typically includes shelves or compartments to hold and/or organize ingredients 308 or other items used in the preparation of meals. A storage unit includes, but is not limited to, a refrigeration unit, a pantry, a storeroom, a cabinet, shelves, cupboards, a boxcar, a trailer, and/or any other compartment or container having space for storing and/or displaying items.

Ingredients 308 stored in storage unit 310 may be identified and tracked by affixing identification (ID) tags 312 to ingredients 308. Identification tags 312 is one or more tags associated with an ingredient from ingredients 308. Identification tags 312 may be, without limitation, a bar code pattern, such as a Universal Product Code (UPC) or a European article number (EAN), a radio frequency identification (RFID) tag, or other optical identification tag.

Ingredients 308 are identified and tracked by tag readers 314. Tag readers 314 are devices that are configured to read or otherwise interact with identification tags 312. Tag readers 314 may include, for example, Universal Product Code readers, radio frequency identification tag readers, or optical identification tag readers. In addition, ingredients 308 may also be identified and tracked by set of sensors 316. Set of sensors 316 are one or more sensors that collect input data 318 from a monitored environment. Set of sensors 316 may include, without limitation, motion detectors, video cameras, infrared cameras, audio-based sensors, biometric sensors, or any other device capable of gathering input data 318.

Input data 318 is data relating to events, conditions, and occurrences in a monitored location. Input data 318 is collected by set of sensors 316. Input data 318 may include, for example, video data that may be used to identify ingredients 308. For example, set of sensors 316 may include a video camera. The video camera may be used to capture an image of a jar of jelly placed into storage unit 310. Consequently, meal plan controller 306 may populate inventory 320 with an entry for the jar of jelly based upon input data 318 collected from the video camera of set of sensors 316.

Data collected by tag readers 314 and set of sensors 316 may be used to maintain inventory 320 by providing a real-time listing of ingredients 308 stored within storage unit 310. Inventory 320 is a listing or record of ingredients 308 that are available in storage unit 310 for use in planning and preparing meals. Inventory 320 may include a data identifying the name and type of ingredient, a date when the ingredient was purchased, an amount of ingredient remaining, or a date by which the ingredient expires. Inventory 320 may include any other type of information relating to ingredients 308 that may be relevant for the preparation of meals.

An amount of an ingredient stored in storage unit 310 may be determined by mass sensor shelf 322. Mass sensor shelf 322 is one or more shelves of storage unit 310 having a mass sensor grid on an upper surface of the shelf. Each mass sensor associated with a mass sensor shelf is an independent sensor capable of measuring the mass of an object resting on the mass sensor. Each mass sensor transmits mass sensor measurements in the form of mass sensor data to meal plan controller 306 for use in maintaining inventory 320. Updated mass sensor data may be used to determine an amount of an ingredient remaining based upon an original mass of the ingredient minus the tare weight of the container in which the ingredient is stored.

A remaining amount of an ingredient from ingredients 308 may also be determined by analyzing input data 318 gathered by set of sensors 316. For example, a video camera from set of sensors 316 may capture an image of a half-empty jar of mustard. Meal plan controller 306 may then analyze input data 318 describing the amount of mustard remaining to determine the availability of mustard for use in selecting meal plans.

Meal plan controller 306 maintains inventory 320. In particular, meal plan controller 306 receives data collected from tag readers 314 and set of sensors 316 and populates inventory 320 with the data describing the availability of ingredients 308. The data stored within inventory 320 may then be used to select one or more meal plans from meal plan database 324 for preparation. Meal plan controller 306 may initiate the selection of meal plans from meal plan database 324 to present to user 326 based upon the availability of ingredients 308 listed in inventory 320. Meal plan database 324 is a database storing available meal plans and recipes for presentation to user 326.

Inventory 320 is stored in local data storage 328. Local data storage 328 is a data storage device for storing data used for planning meals. Local data storage 328 may be, for example, a hard disk drive, removable storage device, flash drive, or any other data storage device.

Meal plan database 324 may be updated with new meal plans or modified recipes from remote data source 330. Remote data source 330 is a data repository. Remote data source 330 may be, for example, a server, database, table, or other repository storing recipes, meal plans, or other information related to food or food preparation. Meal plan controller 306 may update the data stored in meal plan database 324 using data maintained at remote data source 330.

Meal plan controller 306 selects meal plans from meal plan database 324 based upon nutritional requirements 332. Nutritional requirements 332 are guidelines for selecting meal plans for guests that are present or for prospective guests that may be present. For example, nutritional requirements 332 may state that body builders require a certain level of protein each day or that endurance athletes consume a sufficient amount of carbohydrates. Nutritional requirements 332 may also specify an amount of sugar that may be consumed by a diabetic on a daily basis. Nutritional requirements 332 may be determined based upon data extracted from set of profiles 334. Set of profiles 334 are one or more profiles specifying, for example, an amount of vitamins, nutrients, protein, or other type of nutrients that may be required by a person.

In this illustrative example in FIG. 3, set of profiles 334 includes nutritional profiles 336. Nutritional profiles 336 is one or more profiles specifying dietary requirements and restrictions. Nutritional profiles 336 may include profiles based upon for example, a person's body type, level of physical activity, weight loss goals, or any other criteria. For example, nutritional profiles 336 may include a nutrition profile for bodybuilders, which specifies a high protein diet. Another nutrition profile may be a low fat diet for weight loss, or a low cholesterol diet for controlling high blood pressure. Each guest record stored in guest profile database 344 may be linked to one or more nutritional profiles in nutritional profiles 336.

In addition, nutritional requirements 332 may be derived from medical profiles 338. Medical profiles 338 may be a generic medical profile for medical conditions. For example, medical profiles 338 may include profiles for selecting meals for diabetics, people with ulcers or food allergies, malnutrition, or any other form of medical condition. In addition, medical profiles 338 may also include medical profiles specific to particular individuals. Thus, for example, medical profiles 338 may include information extracted from a user's medical history that details medical conditions and foods that should be eaten or avoided.

Nutritional requirements 332 may also be derived from input data 318 collected from set of sensors 316. For example, if a video camera from set of sensors 316 detects a person in a monitored location testing for a blood sugar level, then meal plan controller 306 may select meal plans to satisfy the nutritional requirements beneficial to diabetics. However, in other instances, nutritional requirements 332 may be predicted based upon a selection of a set of prospective guests that may be present for consuming a meal. The presence of a set of prospective guests may be determined by any now known or later developed method.

In the illustrative embodiment in FIG. 3, prospective guests may be identified by calendaring application 340. Calendaring application 340 is a software application that facilitates planning, managing, and scheduling appointments, meetings, birthdays, vacations, or other special events. Calendaring application 340 may be, for example, a calendar and email application, such as Outlook or Eudora. Outlook is a trademark of Microsoft Corporation. Eudora is a trademark of Qualcomm Inc. Additionally, calendaring application 340 may be an event planning software application such as Evite. Evite is a trademark of Evite, Inc. Users of Evite provide RSVPs indicating whether they will attend a particular event.

Meal plan controller 306 may identify prospective guests from calendaring application 340 by parsing calendaring application data to identify guests. Calendaring application data is data transmitted, received, or otherwise managed by calendaring application 340. Calendaring application data includes, for example, email messages, calendar entries, tasks in a list of tasks, or other types of data. Guests may be identified from at least one of a calendar entry or a message or response accepting an invitation to a social event. In other words, meal plan controller 306 may identify prospective guests from either a calendar entry, a message or response accepting an invitation, or both. The message may include, for example, an electronic RSVP submitted via Evite or an Evite-type application for identifying prospective guests.

Alternatively, meal plan controller 306 may identify prospective guests by extracting patterns of historical attendance from historical attendance database 342. Historical attendance database 342 is a database storing data indicating previous dates on which a guest was present at an event. The historical attendance data stored in historical attendance database 342 may include a guest identifier and dates of past attendance. Thus, using data maintained in historical attendance database 342, meal plan controller 306 may predict which guests may be present on any given day or occasion based upon past attendance. For example, if a college-aged son has returned home every year for Thanksgiving for the past three years, then the son's previous attendance for Thanksgiving dinner will be noted in historical attendance database 342. Consequently, meal plan controller 306 may predict that the son will likely attend Thanksgiving dinner this year as well.

Historical attendance database 342 may include the biometric data or metadata describing the biometric data collected by set of sensors 316. Biometric data is data used for identifying guests or other persons in a monitored location. The monitored location may be any location at which meals are prepared, served, and/or consumed. The location may be, for example, a residential kitchen or dining room, a hospital, a nursing home, an extended care facility, a rehabilitation facility, a hotel, or any other location. Biometric sensors may include iris scanners, fingerprint scanners, or other sensors capable of capturing biometric data for identification purposes. Thus, the biometric data collected by a biometric sensor from set of sensors 316 may be used to identify a user present at an event. Relevant information may also be collected and stored in historical attendance database 342. The relevant information may include the types of food that a particular guest ate, how much they ate, how long they stayed, or other information that may facilitate the planning of meals.

In historical attendance database 342, the biometric data or related metadata is stored in a record that also includes a unique identifier assigned to a guest, such as a user identification number. In addition, the record includes a list of dates on which the guest has previously been present at the monitored location. The user identification number may be used as a foreign key linking historical attendance database 342 to other databases stored in local data storage 328. For example, a user identification number may be used to link historical attendance database 342 to guest profile database 344.

Guest profile database 344 is a database storing records for every guest that has previously visited a monitored location or who will likely visit a location in which meals are prepared, served, and/or consumed. The information stored in guest profile database 344 may include, for example, a unique guest identifier, metadata describing the biometric data collected by set of sensors 316, preferred and non-preferred meal plans, and foreign keys linking a guest record from guest profile database 344 with other types of databases maintained in local data storage 328.

In this illustrative example in FIG. 3, guest profile database 344 is linked to one or more medical profiles of medical profiles 338. Guest profile database 344 may also be linked to nutritional profiles 336.

Meal plan policies 346 is one or more rules that govern the selection of meals from meal plan database 324. Meal plan policies 346 may specify, for example, a length of time that an ingredient may be stored in storage unit 310 and thus maintained in inventory 320 before the ingredient is no longer fresh and thus unavailable for use. Thus, if ingredients 308 include milk, meal plan policies 346 may specify that the milk may not be used in a meal if the milk is one week past the sell-by date. Meal plan policies 346 may also direct meal plan controller 306 to select certain meal plans based upon the expiration of certain items from ingredients 308. For example, if cheese will expire in one day and a package of hot dogs will expire in a week, then meal plan policies 346 may specify that meal plan controller 306 shall select a meal plan using the cheese before selecting a meal plan using the package of hot dogs.

This selection, however, may be contingent upon other considerations, such as the nutritional requirements of the set of guests. For example, one such consideration is food-based allergies or other medical conditions of prospective guests that may be specified by medical profiles 338. Another consideration may be whether a guest has an intense dislike for a particular ingredient. Thus, in selecting meal plans, meal plan controller 306 may reference meal plan policies 346 for limiting the selection of meal plans from meal plan database 324. Alternatively, meal plan controller 306 may reference meal plan policies 346 to rank a selected set of meal plans and allow user 326 to choose one of a set of selected meal plans.

For example, if one guest is allergic to nuts, then meal plan controller 306 would not suggest a meal plan including nuts even if nuts were a favorite food ingredient for a meal plan for a second guest. Meal plan controller 306 may thus reference meal plan policies 346 for determining which meal plans have priority over other meal plans. Thus, meal plan policies 346 may specify that meal plans based on medical needs are suggested first, followed closely by meal plans based on a nutrition profile requirements, followed by meal plans based upon favorite food ingredients.

Meal plan policies 346 may also include budgetary limitations. Budgetary limitations are monetary restrictions that may help determine which meal plans from meal plan database 324 may be selected. Thus, the budgetary limitations may direct meal plan controller 306 to select a set of meal plans that conform to a standard deviation of a daily, weekly, monthly, or yearly spending limit. In addition, the budgetary limitations may restrict and govern the amount of money that may be spent on a particular meal, such as breakfast, lunch, or dinner. For example, a meal plan policy of meal plan policies 346 may include a budgetary limitation that selects a set of meal plans for an entire week based upon a predefined budgetary limitation. Thus, for example, meal plan controller 306 may abstain from presenting user 326 with any meal plans that exceed a threshold budget.

User interface 348 is a point of communication between user 326 and meal plan controller 306. User 326 may operate user interface 348 to make menu selections, input new meal plans, update nutrition profiles, or provide meal plan controller 306 with feedback about meals that were suggested. User interface 348 may be a part of computing device 302. User interface 348 may include a digital display and keypad that provides output to user 326 and accepts input from user 326. The digital display is any type of display for providing information to a user in the form of characters, numbers, symbols, or letters.

User interface 348 may also be another computing device at the disposal of user 326. For example, user interface 348 may be a software interface presented to a user on a mobile computing device, such as a smartphone, cell phone, or laptop. In addition, user interface 348 may be an interface attached to storage unit 310. For example, user interface 348 may be a touch screen located on a refrigerator. User 326 may then interact with user interface 348 for selecting meals and providing meal plan controller 306 with data for use in optimizing a selection of meal plans.

Thus, in an illustrative embodiment, meal plan controller 306 identifies a list of prospective guests. The list of prospective guests may be selected from calendaring application 340, or from patterns of guests' attendance extracted from historical attendance database 342. In addition, the list of prospective guests may be manually inputted by user 326 at user interface 348.

Once the list of prospective guests has been derived, meal plan controller 306 identifies ingredients 308 that are available for use in preparing meals. Meal plan controller 306 may identify the existence of ingredients 308 by referencing inventory 320. Meal plans may be selected based upon the availability of the ingredient as indicated by information stored in inventory 320.

In addition, meal plan controller 306 identifies nutritional requirements of the set of prospective guests. The nutritional requirements of the set of prospective guests may be identified by associating a guest's record from guest profile database 344 with at least one of a set of nutritional profiles 336 and medical profiles 338.

The meal plan controller may also limit the selection of meal plans from meal plan database 324 based upon policies stored in set of meal plan policies 346.

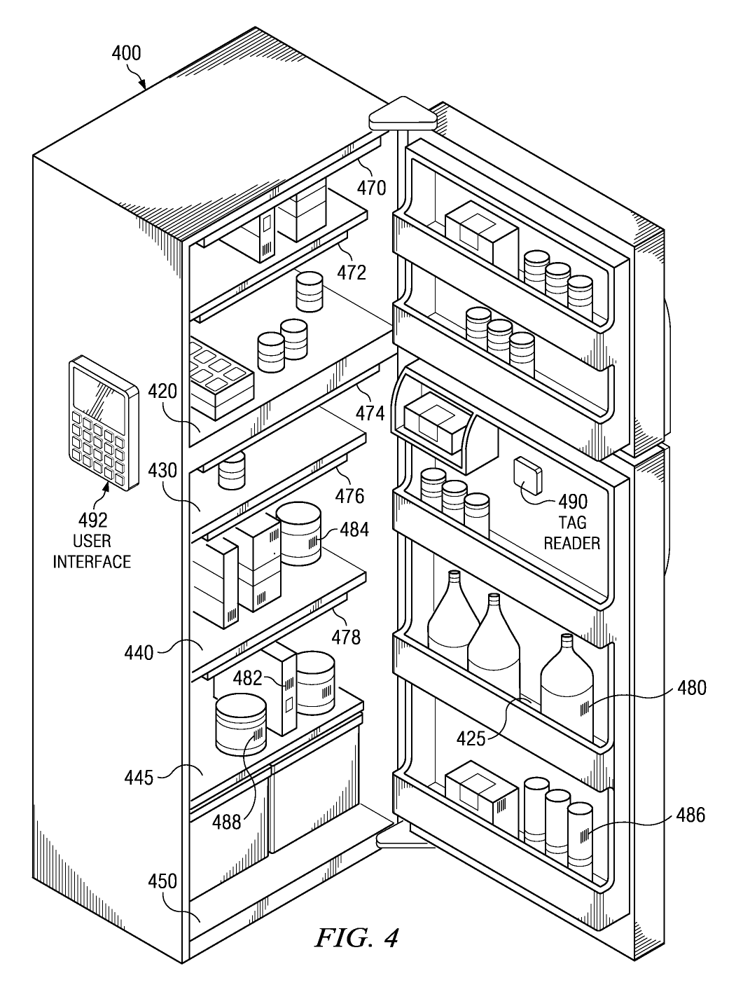

FIG. 4 is a block diagram of a storage unit including a set of mass sensor shelves in accordance with an illustrative embodiment. The storage unit in this illustrative example in FIG. 4 is a refrigeration unit. As used herein, a refrigeration unit is any device, appliance, cabinet, or room for storing food or any other substance at a lower temperature than room temperature. For example, a refrigeration unit includes a refrigerator, a freezer, a combination refrigerator and freezer, an ice box, a refrigerated railcar, a meat locker, an industrial refrigerator, an industrial freezer, a chest freezer, a reach-in cabinet, meat cases, frozen food cabinets, beverage coolers, food service carts, ice cream cabinets, soda fountain units, and any other known or available device or appliance for storing solid, semi-solid, or liquid items at a temperature lower than room temperature. However, in alternate embodiments, storage unit 400 may be a cabinet, pantry, or any other storage unit.

Storage unit 400 is an example of a storage unit, such as storage unit 310 in FIG. 3. Storage unit 400 is any known or available type of refrigerator. In this illustrative example, storage unit 400 is depicted as a consumer size refrigerator/freezer combination appliance. However, the illustrative embodiments are equally applicable to a refrigeration unit of any size, including, but not limited to, an apartment sized refrigerator/freezer, and a room sized industrial refrigerator and/or a room-sized industrial freezer.

Storage unit 400 includes a set of mass sensor shelves. As used here, a set of mass sensor shelves includes a single mass sensor shelf, as well as two or more mass sensor shelves. The set of mass sensor shelves includes mass sensor shelves 420-450. Each mass sensor shelf has a grid of mass sensors. Each mass sensor in the grid is capable of detecting a whole or partial mass of an object. The mass of an object is detected when an object is partially or completely resting on any portion of a mass sensor.

In accordance with the illustrative embodiments, a mass sensor shelf can be any surface having mass sensors that can hold or store an item. For example, mass sensor shelf 420 is a mass sensor shelf located in a freezer compartment of storage unit 400. Mass sensor shelf 425 is a shelf in a door of the refrigerator. Mass sensor shelves 430-445 are mass sensor shelves located in a refrigerator compartment of storage unit 400. Mass sensor shelf 450 is a mass sensor shelf located in the bottom of a drawer of storage unit 400.

Storage unit 400 includes a set of item identifiers, such as identification tags 470-478. Identification tags 470-478 are identification tags such as identification tags 312 in FIG. 3. Identification tags 470-478 identify an item entering or exiting storage unit 400 based on information provided by an identification tag associated with the item.

Storage unit 400 includes a variety of ingredients stored within storage unit 400. The ingredients are ingredients such as ingredients 308 in FIG. 3. A number of the ingredients have an identification tag associated therewith, such as identification tags 480-488.

Tag reader 490 reads identification tags 480-488 as the items are placed into and removed from storage unit 400. However, in another embodiment, a tag reader may be incorporated within the mass sensor shelf itself. For example, where the identification tags are radio frequency identification tags and the tag reader is a radio frequency identification tag reader, the mass sensor shelf is capable of transmitting an interrogate signal to radio frequency identification tags within an interrogate zone of the mass sensor shelf. The mass sensor shelf is also capable of receiving radio frequencies transmitted by radio frequency identification tags within a reception range of the mass sensor shelf.

Tag reader 490 is automatically activated to scan for identification tags 480-488 as ingredients are being placed inside and/or removed from storage unit 400. Scanning by tag reader 490 may be triggered when a door to storage unit 400 is opened. In another example, tag reader 490 is activated to scan for identification tags 480-488 when a change in mass sensor data from a set of mass sensors occurs. In yet another alternative example, tag reader 490 is activated on a periodic or cyclical basis to identify and locate items associated with identification tags 480-488.

In an alternative embodiment, identification tags 480-488 may be Universal Product Code bar codes and tag reader 490 is a Universal Product Code scanner. In this embodiment, a user manually scans identification tags 480-488 as the item is placed into and/or removed from storage unit 400. In this manner, the process of the illustrative embodiments can identify each item as the item is scanned for placement inside storage unit 400.

In an embodiment where ingredients stored in storage unit 400 lack identification tags and/or storage unit 400 lacks a tag reader, a user manually enters an item identification in user interface 492 prior to placing the item in storage unit 400. In this example, if a user does not enter an identification for an unidentified item, user interface 492 will prompt the user to enter an item identification via user interface 492.

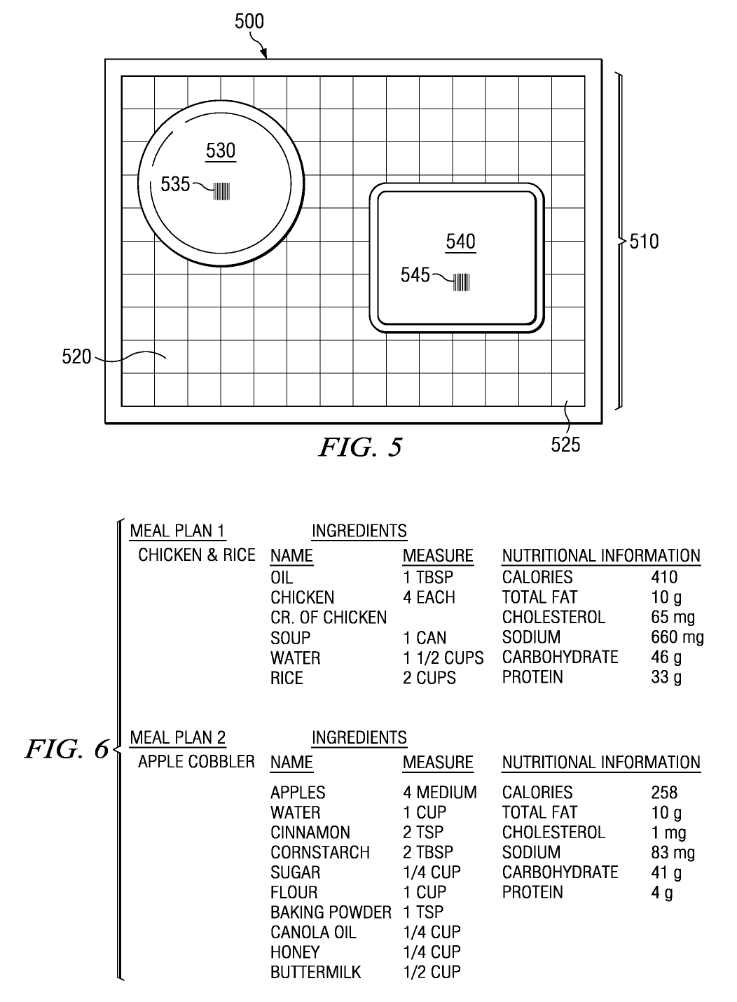

FIG. 5 is a block diagram of a mass sensor shelf having a mass sensor grid and consumable items on the shelf in accordance with an illustrative embodiment. Mass sensor shelf 500 is a mass sensor shelf inside a storage unit. For example, mass sensor shelf is a mass sensor shelf such as mass sensor shelf 322 in storage unit 310 in FIG. 3.

Mass sensor shelf 500 has a mass sensor grid 510 spanning the entire area of an upper surface of mass sensor shelf 500. Mass sensor grid includes a plurality of mass sensors, such as mass sensor 520 and mass sensor 525.

Each block in mass sensor grid 510 represents an individual mass sensor in the plurality of mass sensors. Each sensor is separate and isolated from every other sensor in the mass sensor grid. In this illustrative example, mass sensors 520 and 525, are tiny mass sensors measuring one centimeter by one centimeter. In accordance with the illustrative embodiments, mass sensors can be any shape and any size. For example, mass sensors 520 and 525 can measure one centimeter by two centimeters, or any other size.

Mass sensors in mass sensor grid 510 can measure a mass of an item wholly or partially placed on top of a given mass sensor. Thus, when an object is placed on a mass sensor shelf, each mass sensor covered by the object will generate mass data regarding a portion of the object. The process utilizes mass data from the set of mass sensors covered by an object on a mass sensor shelf to determine the mass of the object.

Jar of peanut butter unit 530 is located on mass sensor shelf 500. Jar of peanut butter unit 530 rests on a set of mass sensors of mass sensor grid 510. The set of mass sensors generates mass data regarding the mass of jar of peanut butter unit 530. Jar of peanut butter unit 530 is associated with identification tag 535. Identification tag 535 is an identification tag, such as identification tags 312 in FIG. 3. Identification tag 535 is read by a tag reader, such as tag reader 314 in FIG. 3 to identify jar of peanut butter unit 530 as a jar of peanut butter.

In this example, a Tupperware of tuna salad is also located on mass sensor shelf 500. The Tupperware of tuna salad unit 540 is associated with identification tag 545. Identification tag 545 is an identification tag such as identification tags 312 in FIG. 3. A tag reader such as tag reader 314 in FIG. 3 may read identification tag 545 to identify Tupperware of tuna salad unit 540 as a Tupperware of tuna salad. A set of mass sensors covered by Tupperware of tuna salad unit 540 generate mass data regarding the mass of Tupperware of tuna salad unit 540. Thus, when an object is placed on a mass sensor shelf, the object will rest on a set of mass sensors on the portion of the shelf covered by the object. Each mass sensor in the set of mass sensors transmits mass data regarding the mass of the object to a meal plan controller, such as meal plan controller 306 in FIG. 3.

The meal plan controller creates a mass footprint for the identified item. The mass footprint is an impression of a shape of a portion of the identified item in contact with a portion of the mass sensor shelf. The portion of the mass sensor shelf in contact with the identified item is the set of mass sensors transmitting mass data regarding the mass of the identified item. In this example, jar of peanut butter unit 530 has a mass footprint indicating a current mass of jar of peanut butter unit 530 and a shape of the surface of jar of peanut butter unit 530 in contact with mass sensor shelf 500. The shape indicated by the mass footprint is round. In this example, either the top or bottom of the jar of peanut butter is in contact with a portion of mass sensor shelf 500.

Likewise, the mass footprint for Tupperware of tuna salad unit 540 indicates a current mass of Tupperware of tuna salad unit 540 as well as a shape of the surface of Tupperware of tuna salad unit 540 in contact with a portion of mass sensor shelf 500. In this example, Tupperware of tuna salad unit 540 has a square shaped mass footprint, as the surface of the Tupperware of tuna salad in contact with mass sensor shelf 500 is square. In this case, the surface of the Tupperware of tuna salad in contact with a portion of the mass sensor shelf could include a top, a bottom, or a side of a square Tupperware container.

In the illustrative embodiment shown in FIG. 5, the mass sensor shelf includes a grid array containing a mass sensor for each portion of the grid. The grid array determines a current mass for an item in contact with the grid array, as well as a mass footprint or impression of the portion of the item in contact with the grid array.

However, in another exemplary embodiment, the grid array includes a single mass sensor, rather than a plurality of mass sensors in a grid. In this example, the grid array is used only in the calculation of the mass footprint or impression of the item in contact with the shelf to create a footprint for the item. The mass of the item is determined by subtracting a previous mass for the entire shelf, including all items on the shelf, from a current mass for the entire shelf, also including all items on the shelf.

Thus, mass change is identified by placing an item on the given shelf and measuring the resultant change in total mass of the shelf. The control application correlates the change in mass with the resultant change in mass footprint data. The change in mass footprint data is due to the additional mass of the item added to the given mass sensor shelf. The change in mass is associated with a newly detected mass footprint for the item. The newly detected mass footprint and the change in mass for the entire shelf are associated with the item placed on the given mass sensor shelf when the change in mass and mass footprint data are detected. The change in mass footprint data may be used to determine an amount of the item remaining.

FIG. 6 is a diagram illustrating meal plan stored in a meal plan database in accordance with an illustrative embodiment. A set of meal plans includes named ingredients and nutritional information for the meal. A meal plan controller compares the nutritional requirements of a set of prospective guests with the nutritional information for each meal plan in the set of meal plans. Each meal plan conforming to the nutritional requirements is included in the set of suggested meal plans presented to a user, such as user 326 in FIG. 3.

In the event that the meal plan controller is selecting a set of meal plans for two or more guests, the meal plan controller may reference a meal plan policy for governing the manner in which meal plans are selected from the meal plan database. In this manner, a set of potential meal plans conforming to the nutritional requirements of more than one prospective guest may be generated.

In another embodiment, two or more sets of nutritional polices can be grouped together to form two or more sets of potential meals. For example, if a husband is on a high protein diet, his wife is on a low carbohydrate diet, one child is on a diet free of peanut oil due to allergies, and another child is on a diabetic diet, the nutritional requirements for the husband and wife can be combined to generate a set of potential meal plans and the nutritional requirements for the two children can be combined to form a second set of potential meal plans for the children.

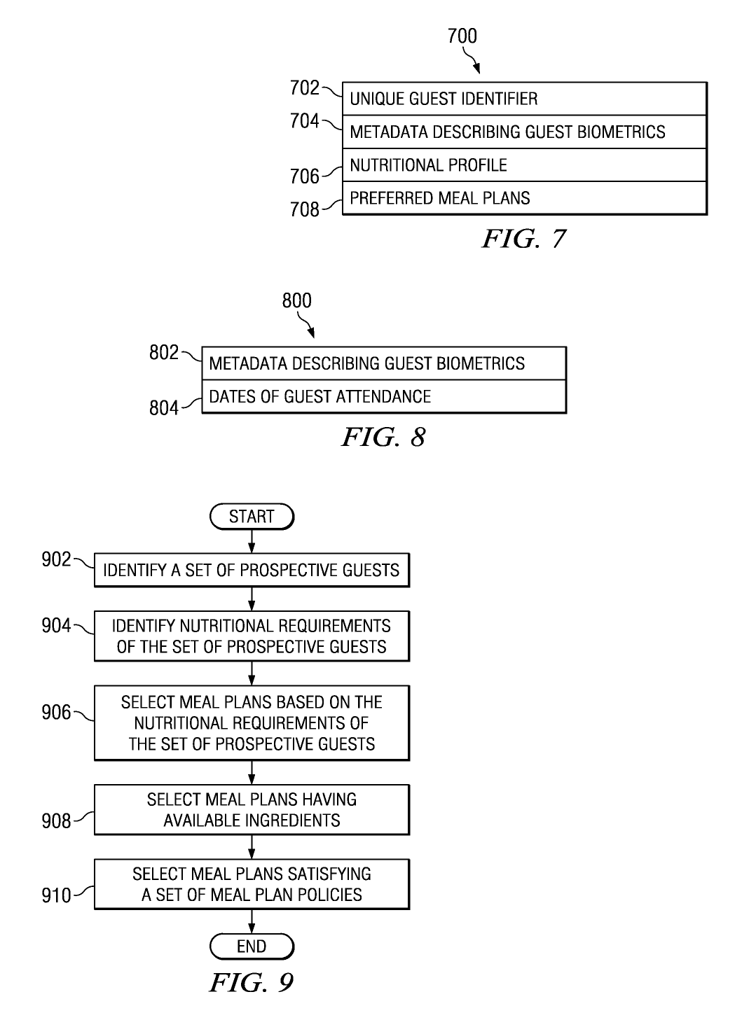

FIG. 7 is a diagram of a record stored in a guest profile database in accordance with an illustrative embodiment. The guest profile database is a guest profile database such as guest profile database 344 in FIG. 3.

Guest profile database 700 includes records having database field 702. Database field 702 is a field storing a guest's unique identifier. In this illustrative example, the unique identifier serves as the primary key in the guest profile database.

Each guest profile record stored in guest profile database 700 is associated with metadata describing guest biometrics stored in database field 704. This association may be made by a user, such as user 326 in FIG. 3. For example, as biometric data of guests is collected by a set of biometric sensors, such as set of sensors 316 in FIG. 3, a user may be prompted to input unique identifiers for each guest.

In addition, each guest profile record includes database field 706. Database field 706 is a field storing information identifying the nutritional profile(s) for the guest. Database field 706 may include, for example, a pointer identifying one or more nutritional profiles stored in nutritional profiles 336 in FIG. 3. Information stored in database field 706 may be provided by a user inputting information in a user interface, such as user interface 348 in FIG. 3.

A guest profile record may also include database field 708 storing information identifying preferred meal plans for the guest. The preferred meal plans may be meal plans about which the guest has provided feedback. For example, if a guest enjoyed a particular meal, then a user may input this feedback into a user interface for inclusion in the guest's profile record. Such information may then be used by a meal plan controller for optimizing a selection of meal plans. For example, a set of meal plan policies may prevent the selection of a meal plan that did not receive favorable feedback.

FIG. 8 is a diagram depicting sample fields of a record stored in a historical attendance database in accordance with an illustrative embodiment. Historical attendance database 800 is a historical attendance database such as historical attendance database 342 in FIG. 3.

In this illustrative example, historical attendance database 800 includes database field 802. Database field 802 is a field storing metadata describing guest biometrics. The guest biometrics are collected from a set of sensors, such as set of sensors 316 in FIG. 3. The metadata stored in database field 802 is generated by a meal plan controller such as meal plan controller 306 in FIG. 3.

The metadata stored in database field 802 may be linked or otherwise associated to database field 704 in guest profile database 700 in FIG. 7. Consequently, a meal plan controller may be able to predict the attendance of prospective guests based upon historical attendance. The attendance of prospective guests is predicted based upon dates of guest attendance stored in database field 804. Database field 804 is a field that stores dates on which the guest described in database field 802 has been present for an event in which meals were served.

For example, metadata stored in database field 802 may identify a family's only daughter that lives in a different country. Date data stored in database field 804 indicates that, for the past few years, the daughter has returned home on her birthday, on Thanksgiving, and on Christmas. Each time the daughter has been present, a set of biometric sensors captured and updated her biometric data. The biometric data was stored in database field 802.

Thus, a meal plan controller is able to predict, from the data stored in historical attendance database 800, that the daughter will likely return home in the following year on the dates stored in database field 804.

FIG. 9 is a flowchart of a process for optimizing a selection of meal plans in accordance with an illustrative embodiment. The process in FIG. 9 may be implemented in a software component such as meal plan controller 306 in FIG. 3.

The process begins by identifying a set of prospective guests (step 902). The set of prospective guests may be identified from at least one of a calendaring application or a historical attendance database. In other words, the set of prospective guests may be identified from either the calendaring application, the historical attendance database, or both.

The process then identifies nutritional requirements of the set of prospective guests (step 904). The nutritional requirements may be identified from at least one of a set of nutritional profiles and a set of medical profiles. Thus, the nutritional requirements may be identified from either the set of nutritional profiles, the set of medical profiles, or both.

The process then selects meal plans based on the nutritional requirements of the set of prospective guests (step 906). In addition, the process selects meal plans based on meal plans having available ingredients (step 908) and selects meal plans satisfying a set of meal plan policies (step 910). The process terminates thereafter.

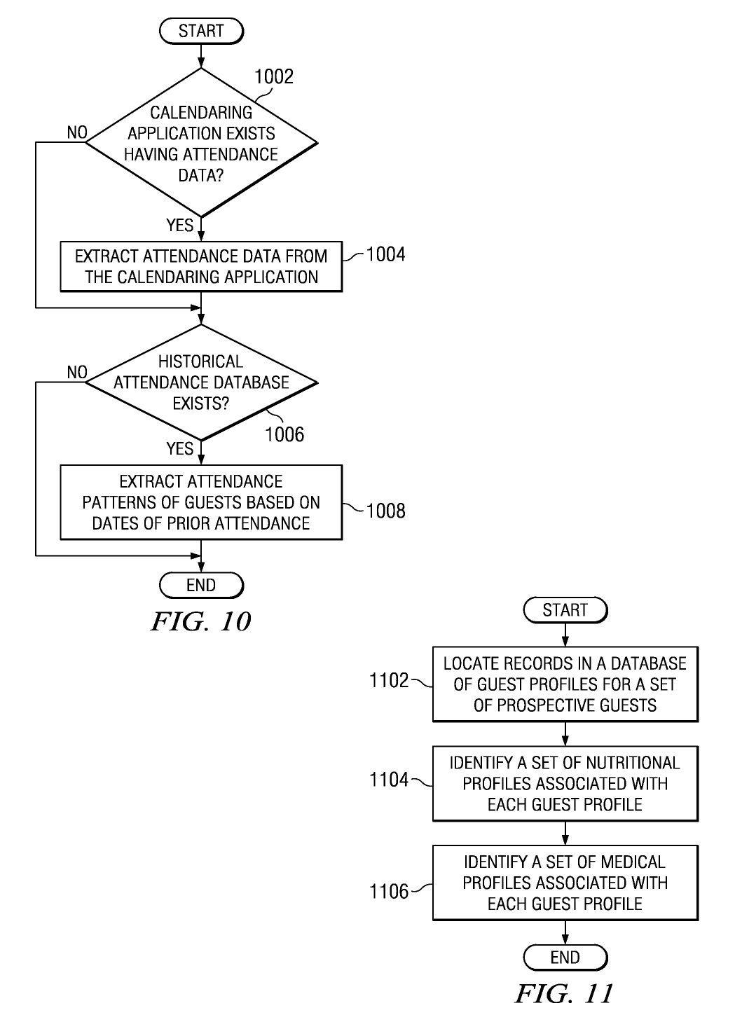

FIG. 10 is a flowchart of a process for identifying a set of prospective guests in accordance with an illustrative embodiment. The process in FIG. 10 may be implemented in a software component such as meal plan controller 306 in FIG. 3.

The process begins by making the determination as to whether a calendaring application exists that has attendance data (step 1002). If the process makes the determination that the calendaring application exists having attendance data, then the process extracts the attendance data from the calendaring application (step 1004).

The process then makes the determination as to whether a historical attendance database exists (step 1006). If the process makes the determination that a historical attendance database exists, then the process extracts attendance patterns of guests based on dates of prior attendance (step 1008) and the process terminates.

Returning now to step 1002, if the process makes the determination that a calendaring application having attendance data does not exist, then the process proceeds to step 1006.

At step 1006, if the process makes the determination that a historical attendance database does not exist, then the process terminates thereafter.

FIG. 11 is a flowchart of a process for identifying nutritional requirements of a set of prospective guests in accordance with an illustrative embodiment. The process in FIG. 11 may be implemented in a software component such as meal plan controller 306 in FIG. 3.

The process begins by locating records in a database of guest profiles for a set of prospective guests (step 1102). The process then identifies a set of nutritional profiles associated with each guest profile (step 1104). Thereafter, the process identifies a set of medical profiles associated with each guest profile (step 1106) and the process terminates.

Thus, the illustrative embodiments provide a computer implemented method, apparatus, and computer program product for optimizing a selection of meal plans. In one embodiment, a set of prospective guests are identified from at least one of a set of sensors collecting historical attendance data and a calendaring application. A set of nutritional requirements is then identified for the set of prospective guests. Thereafter, a set of meal plans is selected on an availability of ingredients and the nutritional requirements of the set of prospective guests, wherein the availability of ingredients is determined by sensors from the set of sensors monitoring the ingredients.

The meal plans may be generated at any location in which meals may be planned and/or prepared. For example, the meal plans may be generated in a residential kitchen, or in other types of kitchens such as in a restaurant, hospital, nursing home, or cruise ship. The meal plans may be selected according to a set of meal plan policies that reduces waste of ingredients and accommodates the nutritional requirements of a set of prospective guests.

Identification of the set of prospective guests facilitates the selection of meal plans. The prospective guests may be family members or friends when the embodiments discussed herein are applied to a residential kitchen. However, the prospective guests may also be patrons of a restaurant, residents of a nursing home, or guest aboard a cruise ship. Tailoring the selection of meal plans based upon the set of prospective guests eliminates waste, saves money, and may increase profits for businesses.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, such as cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for selection of meal plans, the computer implemented method comprising:
identifying a set of prospective guests from at least one of a set of sensors collecting historical attendance data and a calendaring application;
identifying nutritional requirements of the set of prospective guests; and
selecting a set of meal plans based on an availability of ingredients and the nutritional requirements of the set of prospective guests, wherein the availability of ingredients is determined by sensors from the set of sensors monitoring the availability of ingredients.

2. The computer implemented method of claim 1, wherein the set of meal plans is further selected using a set of meal plan policies.

3. The computer implemented method of claim 2, wherein the set of meal plan policies comprises a budgetary limitation.

4. The computer implemented method of claim 1, wherein identifying the set of prospective guests comprises:
parsing calendaring application data to identify participants attending an event to form the set of prospective guests, wherein the set of prospective guests are identified from at least one of a calendar entry and a message accepting an invitation.

5. The computer implemented method of claim 1, wherein identifying the set of prospective guests comprises:
parsing a database storing historical attendance data to identify dates of past attendance by a set of guests, wherein the historical attendance data is collected by the set of sensors from capturing input data describing past events; and
associating a guest identifier with each guest from the set of guests to form the set of prospective guests.

6. The computer implemented method of claim 1, wherein the nutritional requirements are identified from at least one of a set of profiles and input data from the set of sensors.

7. The computer implemented method of claim 1, further comprising:
receiving user feedback for modifying a selection of the set of meal plans.

8. A computer program product for selection of meal plans, the computer program product comprising:
a computer readable medium;
first program instructions to identify a set of prospective guests from at least one of a set of sensors collecting historical attendance data and a calendaring application;
second program instructions to identify nutritional requirements of the set of prospective guests;
third program instructions to select a set of meal plans based on an availability of ingredients and the nutritional requirements of the set of prospective guests, wherein the availability of ingredients is determined by sensors from the set of sensors monitoring the availability of ingredients; and
wherein the first program instructions, the second program instructions, and the third program instructions are stored on the computer readable medium.

9. The computer program product of claim 8, wherein the third program instructions selects the set of meal plans using a set of meal plan policies.

10. The computer program product of claim 9, wherein the set of meal plan policies comprises a budgetary limitation.

11. The computer program product of claim 8, wherein the first program instructions for identifying the set of prospective guests further comprises:
fourth program instructions for parsing calendaring application data to identify participants attending an event to form the set of prospective guests, wherein the set of prospective guests are identified from at least one of a calendar entry and a message accepting an invitation.

12. The computer program product of claim 8, wherein the first program instructions for identifying the set of prospective guests comprises:
fifth program instructions for parsing a database storing historical attendance data to identify dates of past attendance by a set of guests, wherein the historical attendance data is collected by the set of sensors from capturing input data describing past events; and
sixth program instructions for associating a guest identifier with each guest from the set of guests to form the set of prospective guests.

13. The computer program product of claim 8, wherein the nutritional requirements are identified from at least one of a set of profiles and input data from the set of sensors.

14. The computer program product of claim 8, further comprising:
seventh program instructions for receiving user feedback for modifying a selection of the set of meal plans.

15. A system for selection of meal plans, the system comprising:
a bus system;
a memory connected to the bus system, wherein the memory includes computer usable program code; and
a processing unit connected to the bus system, wherein the processing unit executes the computer usable program code to identify a set of prospective guests from at least one of a set of sensors collecting historical attendance data and a calendaring application; identify nutritional requirements of the set of prospective guests; and select a set of meal plans based on an availability of ingredients and the nutritional requirements of the set of prospective guests, wherein the availability of ingredients is determined by sensors from the set of sensors monitoring the availability of ingredients.

16. The system of claim 15, wherein the set of meal plans is further selected using a set of meal plan policies.

17. The system of claim 15, wherein the processing unit further executes the computer usable program code to parse calendaring application data to identify participants attending an event to form the set of prospective guests, wherein the set of prospective guests are identified from at least one of a calendar entry and a message accepting an invitation.

18. The system of claim 15, wherein the processing unit further executes the computer usable program code to parse a database storing historical attendance data to identify dates of past attendance by a set of guests, wherein the historical attendance data is collected by the set of sensors from capturing input data describing past events; and associate a guest identifier with each guest from the set of guests to form the set of prospective guests.

19. The system of claim 15, wherein the nutritional requirements are identified from at least one of a set of profiles and input data from the set of sensors.

20. The system of claim 15, wherein the processing unit further executes the computer usable program code to receive user feedback for modifying a selection of the set of meal plans.
